(19) United States
(12) Patent Application Publication
(10) Pub. No.: US 2009/0144833 A1
(43) Pub. Date: Jun. 4, 2009

(54) INFORMATION PROCESSING DEVICE AND ITS CONTROL METHOD

(75) Inventor: Hajime GUSHIKEN, Fussa-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/194,376

(22) Filed: Aug. 19, 2008

(30) Foreign Application Priority Data
Nov. 30, 2007 (JP) 2007-311063

(51) Int. Cl. G06F 21/00; G06F 15/177; G06F 1/26

(52) U.S. Cl. 726/27; 713/2; 713/300

(57) ABSTRACT

According to one embodiment, an information processing device includes power section for supplying electric power to a system, a control section for controlling ON/OFF of the power section, a receiving section for receiving location information, a memory section for storing a first location information received by the receiving section when an instruction for booting the system is received, and a second location information received by the receiving section prior to receipt of the first location information, and a restriction section for executing restriction on the system when the control section determines that information, which is based on comparison of the first and second location information, matches a condition for restricting the system.

### CROSS-REFERENCE TO RELATED APPLICATIONS

This application is based upon and claims the benefit of priority from Japanese Patent Application No. 2007-311063, filed Nov. 30, 2007, the entire contents of which are incorporated herein by reference.

### BACKGROUND

1. Field

One embodiment of the present invention relates to an information processing device, and more particularly to an information processing device having a security function based on location information, and its control method.

2. Description of the Related Art

Generally, portable IT devices such as notebook type PCs require measures against theft. For example, Jpn. Pat. Appln. KOKAI Publication No. 2007-102572 discloses an art in which location information of a portable personal computer (PC) is obtained at the time of powering ON, and when it is determined on the basis of the obtained location information that a difference value of the location information exceeds a predetermined threshold value and considered that the portable PC has been stolen, boot of a system of the portable PC is prohibited.

According to the above-mentioned Jpn. Pat. Appln. KOKAI Publication No. 2007-102572, however, there is a problem that location information is obtained only when a system of a computer is running.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an example of an external view of an information processing device according to one embodiment of the present invention.

FIG. 2 is an exemplary block diagram showing an example of a system configuration of the information processing device according to the present embodiment.

FIG. 3 is an exemplary block diagram showing a functional configuration and the like of an EC of the computer according to the present embodiment.

FIG. 4 is an exemplary flowchart explaining a control method to which the information processing device according to the present embodiment is applied.

FIG. 5 is an exemplary schematic diagram of a table indicating conditions, etc. for restricting a system of the information processing device according to the present embodiment.

FIG. 6 is an exemplary schematic diagram of a table indicating history information of the information processing device according to the present embodiment.

### DETAILED DESCRIPTION

Various embodiments according to the invention will be described hereinafter with reference to the accompanying drawings. In general, according to one embodiment of the invention, an information processing device includes: power section for supplying electric power to a system; a control section for controlling ON/OFF of the power section; a receiving section for receiving location information; a memory section for storing a first location information received by the receiving section when an instruction for booting the system is received, and a second location information received by the receiving section prior to receipt of the first location information; and a restriction section for executing restriction on the system when the control section determines that information, which is based on comparison of the first and second location information, matches a condition for restricting the system.

Now, one embodiment of the present invention will be described with reference to accompanying drawings.

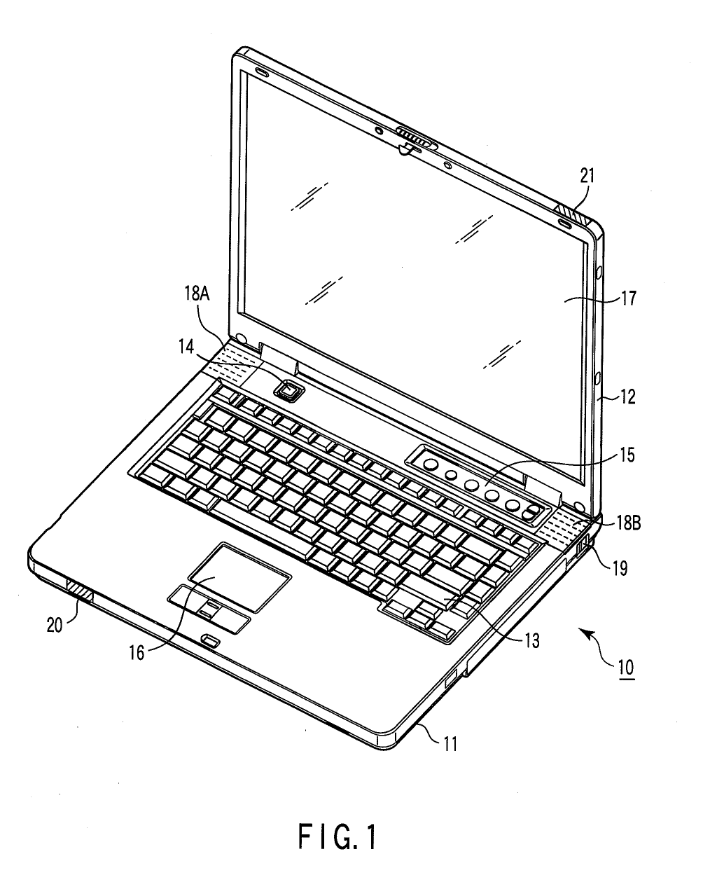

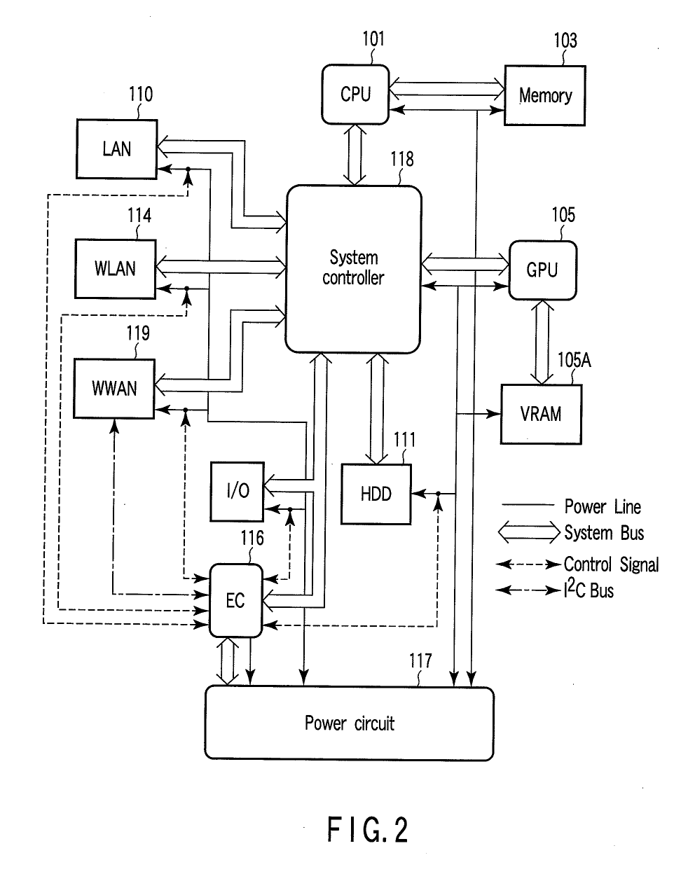

First, a configuration of an information processing device according to one embodiment of the present invention will be explained with reference to FIGS. 1 and 2. This information processing device is realized as, for example, a portable notebook type personal computer 10.

FIG. 1 is a perspective view which shows the computer 10 with its display unit open. The computer 10 comprises a computer body 11 and a display unit 12. A display device comprising a TFT-LCD (Thin Film Transistor Liquid Crystal Display) 17 is incorporated in the display unit 12.

The display unit 12 is attached to the computer body 11 in such a manner that it is rotatable between an open position, where an upper surface of the computer body 11 is exposed, and a closed position, where the upper surface of the computer body 11 is covered. The computer body 11 has a thin box-shaped chassis, and on the upper surface of the computer body 11, a keyboard 13, a power button 14 for powering ON/OFF the computer 10, an input operation panel 15, a touch pad 16, speakers 18A and 18B, a GPS (Global Positioning System) module 21, and the like are arranged. Although the GPS module 21 is provided on the upper surface of the display according to the present embodiment, it may be provided on a main board. In other words, the GPS module 21 may be provided at an arbitrary position depending on receiving characteristic and mounting suitability.

The input operation panel 15 is an input device having a plurality of buttons for respectively activating a plurality of functions, and it is used for inputting an event corresponding to a pressed button. Also, on a front face of the computer body 11, a remote control unit interface section 20 for executing communications with a remote control unit, which remotely controls a TV function of the computer 10, is provided. The remote control unit interface section 20 comprises an infrared signal receiving section, etc.

The GPS module 21 obtains location information by receiving a radio wave from a satellite. Also, a 3G module or the like may be used, instead of the GPS module 21, for measuring electric field strength in order to obtain location information.

Next, a system configuration of the computer 10 will be explained with reference to FIG. 2.

As shown in FIG. 2, the computer 10 comprises a CPU 101, a memory (main memory) 103, a graphics processing unit (GPU) 105, a video memory (VRAM) 105A, a LAN controller 110, a hard disk drive (HDD) 111, a wireless LAN controller 114, an embedded controller (EC) 116, a power circuit 117, a system controller 118, a WWAN (Wireless Wide Area Network) 119, etc. The WWAN 119 is a GPS module 21 obtaining location information or a 3G module, etc. To the EC 116 and the WWAN 119, power should always be supplied from the power circuit 117 via an I2C bus.

The CPU 101 is a processor that controls the performance of the computer 10, and it executes an operating system (OS) and various application programs that are loaded from the HDD 111 to the main memory 103. The CPU 101 also executes a BIOS (Basic Input Output System) stored in a BIOS-ROM. The BIOS is a program for hardware control.

The GPU 105 is a display controller that controls the LCD 17 used as a display monitor of the computer 10. Display signals generated by the GPU 105 are transmitted to the LCD 17.

The EC 116 is an embedded controller for power management. The EC 116 has a function of powering ON/OFF the computer 10 in accordance with operation of the power button 14 performed by a user. Furthermore, the EC 116 obtains location information from the WWAN 119, and, when a difference of the obtained location information (a difference between preliminarily stored location information and present location information) exceeds a preset threshold value, the EC 116 puts boot restriction on the system, or performs control for limiting access to a predetermined area of the HDD 111.

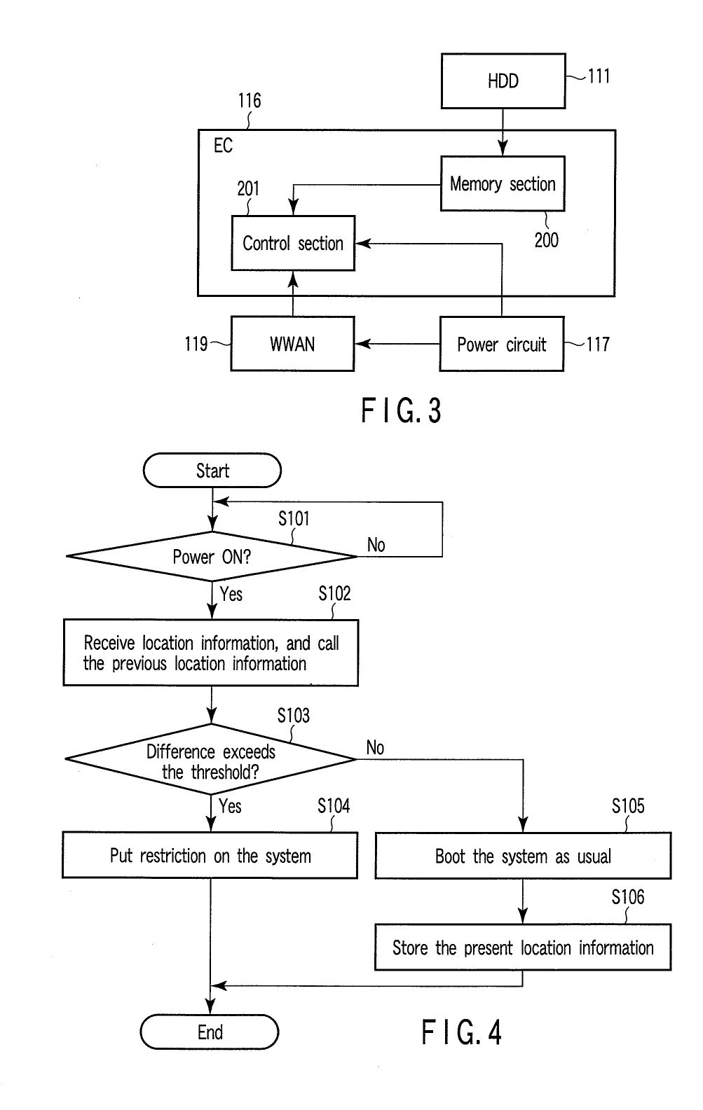

FIG. 3 is a functional block diagram which explains a function of the EC 16. A control method performed by the EC 116 will be explained with reference to FIG. 3.

The EC 116 includes a memory section 200 and a control section 201.

The memory section 200 stores condition information, which is used for putting a restriction on the system, and the preliminarily obtained location information, etc. An example of the condition information used for putting restriction on the system is a case where a difference in location information is within a predetermined threshold value (e.g., 1 km), or a difference in location information exceeds the threshold value. The control section 201 determines whether or not to boot the system on the basis of the location information received by the WWAN 119 and the condition information for putting restriction on the system, when a boot instruction of the system of the computer 10 is received. When the control section 201 determines that the location information matches the condition for putting restriction on the system, the control section 201 puts restrictions on the system. As a restriction on the system, either one of restricting booting of the system or restricting access to the HDD 111 and the memory section 200 is performed. Restrictions on the system are configurable, without being limited to the above.

Next, a control method to which the information processing device according to the present embodiment is applied will be explained with reference to a flowchart shown in FIG. 4.

To the EC 116 and the WWAN 119, power should always be supplied from the power circuit 117.

The EC 116 constantly monitors power of the system, and obtains location information indicating where the computer 10 is presently located from the WWAN 119, when the system is powered ON (YES of Block S101). The EC 116 also calls the previous location information stored in the memory section 200 or the like (Block S102). The EC 116 compares the present location information with the previous location information for calculating a difference. When the difference is determined to exceed the predetermined threshold value (e.g., 1 km) (YES of Block S103), the EC 116 puts restriction on the system (Block S104). The restriction put on the system is, as shown in FIG. 5 for example, stored in the memory section 200 or the like as table information. Boot restriction conditions may be set when, for example, a determination result of whether or not a difference in the location information exceeds the predetermined threshold value. This threshold value is set to, for example, 1 km. Restriction content 1 is a process of restricting boot of the system (not to boot the system), and restriction content 2 is a process of restricting access to the HDD 111 and the memory section 200 (not to permit access to the predetermined area). Which restriction contents are to be executed can be preliminarily set. Also, it is possible to set a plurality of threshold values, and to set restrictions with certain conditions when the difference in the location information exceeds respective threshold values.

On the other hand, when the EC 116 determines that the difference is within the predetermined value (e.g., 1 km) in Block S103 (NO of Block S103), the system is booted as usual (Block S105). Then, the memory section 200 stores the present location information (Block S106).

According to the above-described embodiment, it is possible to obtain location information before boot of the system and provide a security function using the obtained location information. Furthermore, since location information can be obtained before boot of the system, it is possible to build a system that does not depend on an OS or an application. Further, ON/OFF of a password function at a BIOS level can be automated. Also, the resistance against hacking during starting up in safe mode becomes high.

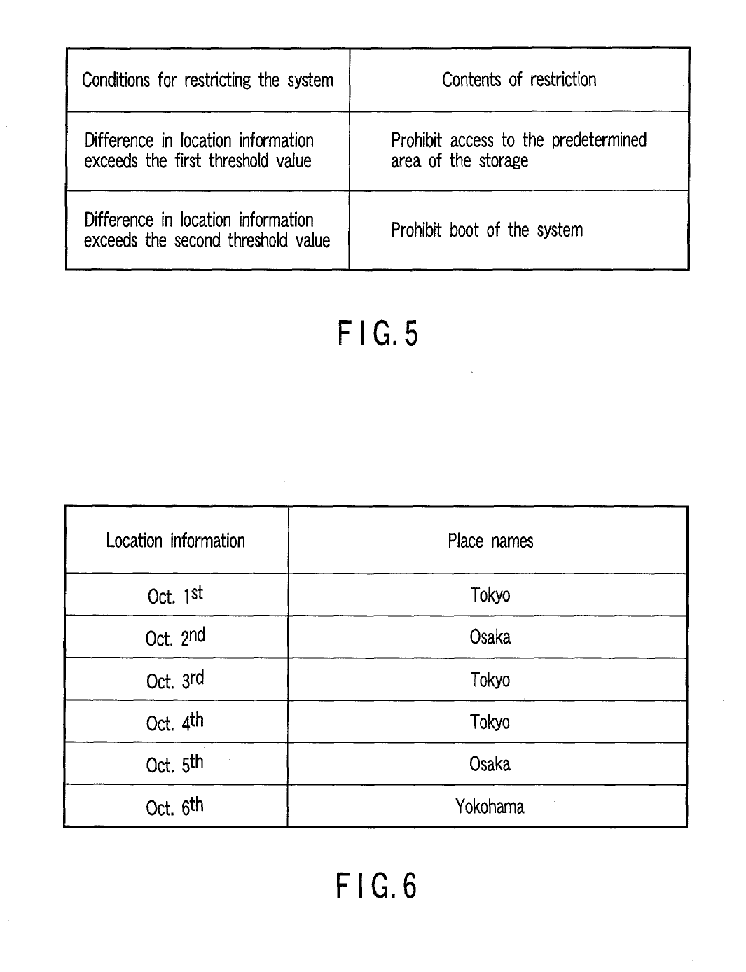

As a modification example of the above-described embodiment, history information of location information may be kept as a log, as shown in FIG. 6. For instance, assume a case where location information is kept as a log while being converted into place names. When a history showing travel performed between October 1^{st} and October 6^{th} is referred to, there is a history indicating “Tokyo” and “Osaka”, but only “Yokohama” does not match other place names in the history, which means “Yokohama” is a new name. In this case, even if “Tokyo” and “Yokohama” are within a distance of 1 km and the difference does not exceed the threshold, it is possible to set a condition to restrict boot of the system. Conversion of location information into place names is realized in such a manner that the GPS module 21 obtains longitude, latitude, and height, and a user preliminarily sets names on the basis of the obtained longitude, latitude and height.

Furthermore, it is also possible to encrypt location information obtained from the WWAN 119 via the I2C bus, and to set the I2C bus as a dedicated bus. Usable for the WWAN 119 are: a wireless system such as WiMAX (Worldwide Interoperability for Microwave Access), an infrared ray/visible optical communication device utilizing a lighting equipment, etc. When the infrared ray/visible optical communication device is used, for example, infrared ray/visible optical communication devices are provided for each of the rooms in a building so that travel between the rooms can be detected. For example, when the infrared ray/visible optical communication device is used, it is possible to configure the following settings: to make a specific area of the HDD 111 invisible to a user when the PC is not accessed from a specific area of a specific building; and to make the system ask a user to input a password or a reading key when the PC is accessed from outside a specific area of a specific building, without providing a user with a password or a reading key of an encrypted data for accessing specific data on an intranet before boot of the system. In the case where the infrared ray/visible optical communication device is used, it is advantageous in setting coverage of security more comprehensively than a device using radio waves.

The present invention is made in consideration of above described circumstances, and has an object to provide an information processing device capable of having a security function based on obtained location information, and its control method.

As mentioned above, the present invention is not limited to the above explanation, and the present invention can be modified and put into practice without departing from the gist of the present invention. Also, the plurality of structural elements disclosed in the above embodiment can be appropriately combined to form various inventions. For example, some structural elements can be deleted from the all of the structural elements that are disclosed in the embodiment. Further, the structural elements in the different embodiments can be properly combined.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing device comprising:
a power supply for supplying electric power to a system;
a controller for controlling the power supply;
a receiver for receiving location information;
a memory for storing a first location information received by the receiver when an instruction for booting the system is received, and a second location information received by the receiver prior to receipt of the first location information; and
a restriction module for executing a restriction on the system based on a comparison of the first and second location information by the controller.

2. The information processing device of claim 1, wherein the restriction is put on the system when a difference between the first location information and the second location information exceeds a predetermined threshold value.

3. The information processing device of claim 2, wherein booting of the system is prohibited when the difference between the first location information and the second location information exceeds the threshold value.

4. The information processing device of claim 2, wherein, access to a predetermined area of the memory is prohibited after boot of the system when the difference between the first location information and the second location information exceeds the threshold value.

5. The information processing device of claim 1, wherein the receiver is either a GPS module or a 3G module.

6. A control method used in an information processing device having a memory, a power supply for supplying power to a system, a controller for controlling the power supply, and a receiver for receiving location information, wherein the control method comprises:
receiving a first location information by the receiver, when an instruction for booting the system is received;
comparing the first location information and a second location information received by the receiver prior to the receipt of the first location information and stored in the memory;
putting a restriction on the system based on the comparison of the first location information and the second location information.

7. The control method of claim 6, further comprising putting the restriction on the system when a difference between the first location information and the second location information exceeds a predetermined threshold value.

8. The control method of claim 7, further comprising prohibiting booting of the system when the difference between the first location information and the second location information exceeds the predetermined threshold value.

9. The control method of claim 7, further comprising prohibiting access to a predetermined area of the memory after booting of the system, when the difference between the first location information and the second location information exceeds the predetermined threshold value.
